(19) United States
(12) Patent Application Publication
(10) Pub. No.: US 2022/0341588 A1
(43) Pub. Date: Oct. 27, 2022

(54) METHOD FOR SETTING PARAMETERS OF LOAD FEEDFORWARD CONTROLLER FOR SUPERHEATED STEAM TEMPERATURE CONTROL

(71) Applicant: Southeast University, Nanjing (CN)

(72) Inventors: Gang JU, Nanjing (CN); Zhenhua REN, Nanjing (CN)

(73) Assignee: Southeast University, Nanjing (CN)

(21) Appl. No.: 17/723,171

(22) Filed: Apr. 18, 2022

(30) Foreign Application Priority Data
Apr. 25, 2021 (CN) 202110445886.0

(51) Int. Cl. F22G 5/12; F22G 5/20; F22G 5/02

(52) U.S. Cl. CPC F22G 5/126; F22G 5/20; F22G 5/02

(57) ABSTRACT

Disclosed is a method for setting parameters of a load feedforward controller for superheated steam temperature control, which belongs to the technical field of thermal automatic control. This method adds a load feedforward controller to the conventional boiler superheated steam temperature spray desuperheating cascade control system. The application provides a structure of the load feedforward controller, and a method for designing the parameters of the load feedforward controller according to the dynamic characteristics of the superheated steam temperature related to feed coal flow disturbance, feedwater flow disturbance and desuperheating water spray disturbance. The method of the application could effectively reduce the superheated steam temperature deviation in the process of unit load rise or drop, and the design method is simple, effective and easy to realize in engineering.

### CROSS-REFERENCE TO RELATED APPLICATIONS

This application claims priority to Chinese Patent Application No. 202110445886.0, filed on Apr. 25, 2021, the contents of which are hereby incorporated by reference.

### TECHNICAL FIELD

The application belongs to the technical field of thermal automatic control, and in particular to a method for setting parameters of a load feedforward controller for superheated steam temperature control.

### BACKGROUND

A superheated steam temperature is an important parameter of a unit. Excessive superheated steam temperature will cause reduced strength of a steam pipeline, and even lead to pipeline explosion; a too low superheated steam temperature will reduce the thermal economy of the unit, and water hammering may occur after steam makes its way into steam turbine, which will affect the safe operation of the steam turbine. The quality of superheated steam temperature control affects unit economical features and the safety of the whole unit.

For once-through boilers, the superheated steam temperature is greatly influenced by the coal-water ratio. Because the influence of feed coal flow disturbance and feedwater flow disturbance on dynamic characteristics of the superheated steam temperature are quite different, the superheated steam temperature often has large deviation from set value during load rise or drop process of the unit, which seriously affects the operation safety of the unit.

In recent years, as new energy sources such as photovoltaic and wind power develop, thermal power units have to regulate peak loads, and the load of units often changes greatly. At present, the control of a superheated steam temperature in power plants mainly is cascade control, which has been difficult to meet the peak load regulation requirements of units.

### SUMMARY

In view of the problem that the superheated steam temperature deviation of once-through boiler is large in the process of unit load rise or drop, the application provides a parameter setting method of a load feedforward controller for superheated steam temperature control, which reduces the superheated steam temperature deviation in the process of unit load rise or drop by designing the control parameter of the load feedforward controller.

To achieve the above objective, a technical scheme adopted by the application is as follows:

a method for setting parameters of a load feedforward controller for superheated steam temperature control includes adding a load feedforward controller in a superheated steam temperature spray desuperheating cascade control system, and the load feedforward controller G_{F}(s) adopts the following transfer function:

$${G}_{F} ( s ) = - \frac{{K}_{F} s ( 1 + {T}_{1} s )}{( 1 + {T}_{2} s )} ,$$

where K_{F}, T₁, and T₂ are parameters of the load feedforward controller; the output Ne′ of a load processing module which processes the unit power Ne is served as the input of the load feedforward controller, and the output of the load feedforward controller and the output of the secondary controller of the cascade control system are added up;

the load processing module calculates the output of the module according to the following method:

$${Ne}^{′} = \frac{Ne - Ne \_min}{Ne \_max - Ne \_min}$$

in which Ne_max, Ne_min are the maximum and minimum load of the unit respectively;

the parameter setting steps of the load feedforward controller G_{F}(s) are as follows:

S1: for a unit, switching its unit load control system to manual, its superheated steam temperature control system and its reheat steam temperature control system to manual, and its boiler combustion control system to automatic, and making the unit in a stable state;

S2: under the stable state in S1, step reducing of the total feed coal flow of the unit by 1% of the rated total feed coal flow, and collecting the variation values of the superheated steam temperature with T seconds as the sampling period to obtain the unit step response data ΔTₕ(k) of the superheated steam temperature, where k=1, 2, . . . , N, N is the number of sampling data;

S3: making the unit in the stable state in S1, step reducing of the feedwater flow of the unit by 1% of the rated feedwater flow, and taking T seconds as the sampling period, collecting the variation values of the superheated steam temperature to obtain the unit step response data ΔT₂(k) of the superheated steam temperature;

S4: calculating a data sequence ΔT(k), ΔT(k)=ΔT₁(k)+ΔT₂(k) and searching the maximum value of the data sequence ΔT(k) and the sampling time corresponding to the maximum value, which are respectively recorded as K₀ and T₀; calculating out the data sequence DT(k), where k=1, 2, . . . , N−1, DT(k)=ΔT(k+1)−ΔT₂(k), finding out the sampling time corresponding to the maximum value in the data sequence DT(k), and recording it as Tq;

S5: keeping the unit in the stable state in S1, step reducing of the opening of the superheated steam spray desuperheating valve by 5%, taking T seconds as the sampling period, collecting the variation values of the superheated steam temperature, obtaining the unit step response curve of the superheated steam temperature, and calculating out the characteristic parameters τ, Tₚ and Kₚ of the step response curve;

τ is a lag time, the value of which is the intersection point value of the tangent at the inflection point on the step response curve and the abscissa axis; Tₚ is a time constant whose value is the time required to change from the inflection point value to the final equilibrium value at the maximum speed on the step response curve;

Kₚ is a steady-state gain, and its value is the ratio of the steady-state value of the variation values of the superheated steam temperature and the variation value of the opening of the superheated steam spray desuperheating valve;

S6: based on the calculation results of S4 and S5, calculating the parameter K_{F} of the load feedforward controller G_{F}(s) as follows:

$$\{ \begin{matrix}{K}_{F} = \frac{{K}_{1}}{{K}_{p}} \\ {K}_{1} = \frac{{K}_{0} T}{{e}^{- ( n - 1 )}} \frac{( n - 1 ) !}{{( n - 1 )}^{n - 1}} \\ n = {( \frac{{T}_{0}}{{T}_{0} - {T}_{q}} )}^{2} + 1\end{matrix} ;$$

calculating parameters T₁ and T₂ of the load feedforward controller G_{F}(s) as follows:

$$\{ \begin{matrix}{T}_{1} = {T}_{2} + {T}_{p} + τ - ( {T}_{0} + x ) \\ \begin{matrix}{T}_{2} = \frac{2 τ {T}_{p} + {( τ - {T}_{0} - x )}^{2} + ( x - 2 {T}_{p} ) ( {T}_{0} + x )}{2 ( {T}_{p} + τ - {T}_{0} - x )} \\ x = \frac{{( {T}_{0} - {T}_{q} )}^{2}}{{T}_{0}}\end{matrix}\end{matrix} ,$$

where x represents an intermediate variable.

The method has the advantages that the parameters of the load feedforward controller for superheated steam temperature control are set according to the dynamic characteristics of the superheated steam temperature related to the feed coal flow disturbance, feedwater flow disturbance and desuperheating water spray disturbance, which can effectively reduce the superheated steam temperature deviation during the unit load rise or drop process and improve the safe and economical operation level of the unit; the method of the application is simple and easy to implement in engineering.

### BRIEF DESCRIPTION OF THE DRAWINGS

FIG. 1 is a block diagram of superheated steam temperature control principle.

FIG. 2 shows a process step response curve and its characteristic parameters.

FIG. 3 is a flow chart of parameter setting steps of a load feedforward controller.

### DETAILED DESCRIPTION OF THE EMBODIMENTS

In order to better explain the technical scheme disclosed by the application, the following description will be further elaborated with reference to the attached drawings and specific implementation cases.

The present application adds a load feedforward controller to the conventional boiler superheated steam temperature spray desuperheating cascade control system, as shown in FIG. 1. In the figure, G₂(s) and G₁(s) are the transfer functions of the superheated steam temperature process in leading zone and inert zone respectively, G_{c1}(s) and G_{c2}(s) are the primary controller and the secondary controller of the cascade control system respectively, Y is superheated steam temperature, R is set value of the superheated steam temperature and Y′ is the leading steam temperature. For the load feedforward controller G_{F}(s), the following transfer function is adopted:

$${G}_{F} ( s ) = - \frac{{K}_{F} s ( 1 + {T}_{1} s )}{( 1 + {T}_{2} s )} ,$$

where K_{F}, T₁ and T₂ are parameters of the load feedforward controller; the output Ne of the load processing module which processes the unit power Ne is used as the input of the load feedforward controller, and the output of the load feedforward controller and the output of the secondary controller of the cascade control system are added up.

The load processing module calculates the output of the module according to the following method:

$${Ne}^{′} = \frac{Ne - Ne \_min}{Ne \_max - Ne \_min} ,$$

where Ne_max, Ne_min are the maximum and minimum loads of the unit respectively.

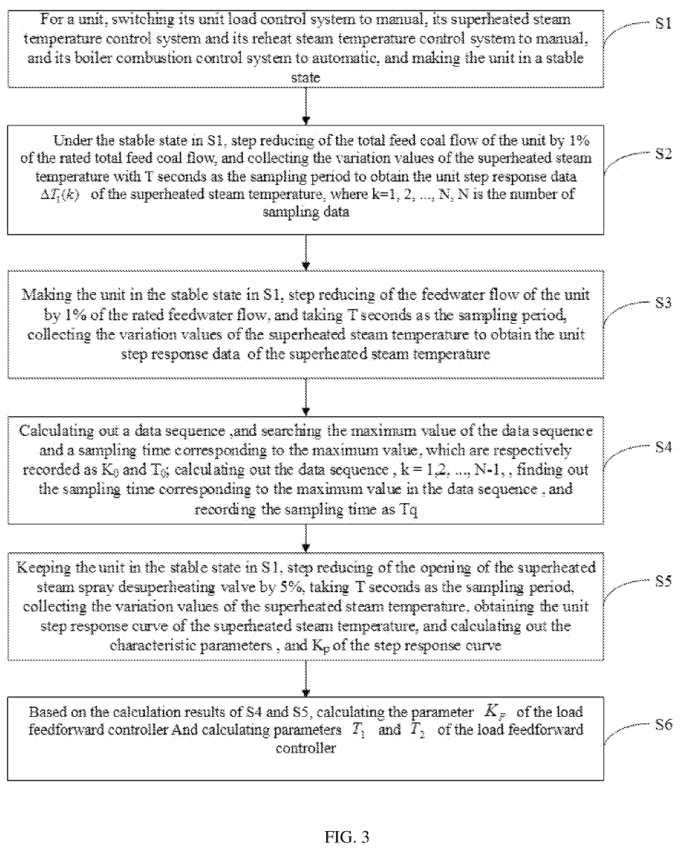

As shown in FIG. 3, the parameters of the load feedforward controller G_{F}(s) are determined by the following methods and steps:

S1: switching a unit load control system to manual, a superheated steam temperature control system and a reheat steam temperature control system to manual, and a boiler combustion control system to automatic, and making the unit in a stable state;

S2: under the stable state in S1, step reducing of the total feed coal flow of the unit by 1% of the rated total feed coal flow, and collecting the variation values of the superheated steam temperature with T seconds as the sampling period to obtain the unit step response data ΔT₁(k) of the superheated steam temperature, where k=1, 2, . . . , N, N is the number of the sampling data;

S3: making the unit in the stable state in S1, step reducing of the feedwater flow of the unit by 1% of the rated feedwater flow, and taking T seconds as the sampling period, collecting the variation values of the superheated steam temperature to obtain the unit step response data ΔT₂(k) of the superheated steam temperature, k=1, 2, . . . , N;

S4: calculating a data sequence ΔT(k), k=1, 2, . . . , N, ΔT(k)=ΔT₁(k)+ΔT₂(k) and searching the maximum value of the data sequence ΔT(k) and the sampling time corresponding to the maximum value, which are respectively recorded as K₀ and T₀; calculating out the data sequence DT(k), k=1, 2, . . . , N−1, DT(k)=ΔT(k+1)−ΔT(k), finding out the sampling time corresponding to the maximum value in the data sequence DT(k), and recording it as Tq;

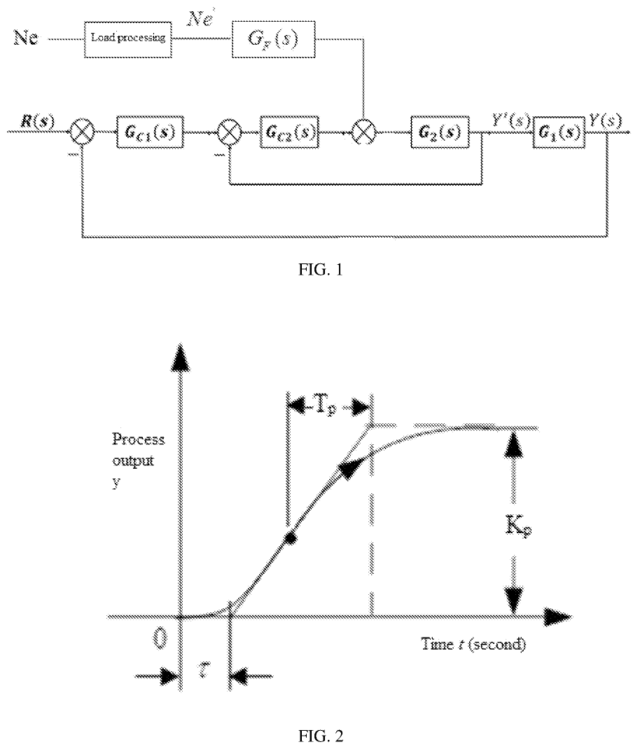

S5: keeping the unit in the stable state in S1, step reducing the opening of the superheated steam spray desuperheating valve by 5%, taking T seconds as the sampling period, collecting the variation values of the superheated steam temperature, obtaining the unit step response curve of the superheated steam temperature, and calculating out the characteristic parameters τ, Tₚ and Kₚ of the step response curve; as shown in FIG. 2, τ is the lag time, the value of which is the intersection point value of the tangent at the inflection point on the step response curve and the abscissa axis; Tₚ is a time constant whose value is the time required to change from the inflection point value to the final equilibrium value at the maximum speed on the step response curve; Kₚ is the steady-state gain, and its value is the ratio of the steady-state value of the variation values of the superheated steam temperature and the variation value of the opening of the superheated steam spray desuperheating valve;

S6: based on the calculation results of S4 and S5, calculating the parameter K_{F} of the load feedforward controller G_{F}(s) as follows:

$$\{ \begin{matrix}{K}_{F} = \frac{{K}_{1}}{{K}_{p}} \\ {K}_{1} = \frac{{K}_{0} T}{{e}^{- ( n - 1 )}} \frac{( n - 1 ) !}{{( n - 1 )}^{n - 1}} \\ n = {( \frac{{T}_{0}}{{T}_{0} - {T}_{q}} )}^{2} + 1\end{matrix} ;$$

calculating parameters T₁ and T₂ of the load feedforward controller G_{F}(s) as follows:

$$\{ \begin{matrix}{T}_{1} = {T}_{2} + {T}_{p} + τ - ( {T}_{0} + x ) \\ \begin{matrix}{T}_{2} = \frac{2 τ {T}_{p} + {( τ - {T}_{0} - x )}^{2} + ( x - 2 {T}_{p} ) ( {T}_{0} + x )}{2 ( {T}_{p} + τ - {T}_{0} - x )} \\ x = \frac{{( {T}_{0} - {T}_{q} )}^{2}}{{T}_{0}}\end{matrix}\end{matrix} ,$$

where x represents an intermediate variable.

The following is a detailed description of the summary of the present application by taking a 1000 MW supercritical unit of a power generation limited liability company which adopts the load feedforward controller of the present application for example. Based on this application scenario, the above related parameters are selected as follows:

the maximum and minimum load of the load processing module is taken as: Ne_max=1000 MW, Ne_min=0 MW;

step response curves of S2, S3 and S5 are all obtained under 800 MW load, the sampling period is T=5 s, and the number of samples is N=200;

in S4, the calculated parameters are K₀=0.26, T₀=235 s and Tq=125 s;

in S5, the characteristic parameters of the step response curve are τ=149.5 s, Tₚ=81.2 s and Kₚ=0.622;

the load feedforward controller parameters calculated in step S6 are: K_{F}=10.2, T₁=63.2 and T₂=118.3.

Testing with the method of the application shows that the maximum dynamic deviation of the superheated steam temperature of the unit decreases from 12° C. to 4.5° C. when the load of the unit increases from 800 MW to 900 MW at a rate of 20 MW/min, which suggests that the method of the application can effectively improve the safety and cut down costs of the unit operation.

The above is only the preferred embodiment of the present application, and it should be pointed out that for ordinary technicians in the technical field, without departing from the principle of the present application, improvements and modifications could be made, which should also fall in the protection scope of the present application.

1. A method for setting parameters of a load feedforward controller for superheated steam temperature control, wherein the load feedforward controller is added to a superheated steam temperature spray desuperheating cascade control system, and the load feedforward controller adopts the following transfer function:
$${G}_{F} ( s ) = - \frac{{K}_{F} s ( 1 + {T}_{1} s )}{( 1 + {T}_{2} s )} ,$$
where K_{F}, T₁, and T₂ are parameters of the load feedforward controller; an output Ne′ of a load processing module which processes a unit power Ne is used as an input of the load feedforward controller, and an output of the load feedforward controller and an output of the secondary controller of the superheated steam temperature spray desuperheating cascade control system are added up;
the load processing module calculates the output of the module according to the following method:
$${Ne}^{′} = \frac{Ne - Ne \_min}{Ne \_max - Ne \_min} ,$$
where Ne_max, Ne_min are the maximum and minimum load of the unit respectively;
parameters of the load feedforward controller G_{F}(s) are set according to following steps:
S1: for a unit, switching its unit load control system to manual, its superheated steam temperature control system and its reheat steam temperature control system to manual, and its boiler combustion control system to automatic, and making the unit in a stable state;
S2: under the stable state in S1, step reducing of the total feed coal flow of the unit by 1% of the rated total feed coal flow, and collecting the variation values of the superheated steam temperature with T seconds as the sampling period to obtain the unit step response data ΔT₁(k) of the superheated steam temperature, where k=1, 2, . . . , N, N is the number of sampling data;
S3: making the unit in the stable state in S1, step reducing of the feedwater flow of the unit by 1% of the rated feedwater flow, and taking T seconds as the sampling period, collecting the variation values of the superheated steam temperature to obtain the unit step response data ΔT₂(k) of the superheated steam temperature;
S4: calculating out a data sequence ΔT(k), ΔT(k)=ΔT₁(k)+ΔT₂(k) and searching the maximum value of the data sequence ΔT(k) and a sampling time corresponding to the maximum value, which are respectively recorded as K₀ and T₀; calculating out the data sequence DT(k), k=1, 2, . . . , N−1, DT(k)=ΔT(k+1)−ΔT(k), finding out the sampling time corresponding to the maximum value in the data sequence DT(k), and recording the sampling time as Tq;
S5: keeping the unit in the stable state in S1, step reducing of the opening of the superheated steam spray desuperheating valve by 5%, taking T seconds as the sampling period, collecting the variation values of the superheated steam temperature, obtaining the unit step response curve of the superheated steam temperature, and calculating out the characteristic parameters τ, Tₚ and Kₚ of the step response curve; wherein
τ is a lag time, the value of which is the intersection point value of the tangent at the inflection point on the step response curve and the abscissa axis; Tₚ is a time constant whose value is the time required to change from the inflection point value to the final equilibrium value at the maximum speed on the step response curve;
Kₚ is a steady-state gain, and its value is the ratio of the steady-state value of the variation values of the superheated steam temperature and the variation value of the opening of the superheated steam spray desuperheating valve;
S6: based on the calculation results of S4 and S5, calculating the parameter K_{F} of the load feedforward controller G_{F}(s) as follows:
$$\{ \begin{matrix}{K}_{F} = \frac{{K}_{1}}{{K}_{p}} \\ {K}_{1} = \frac{{K}_{0} T}{{e}^{- ( n - 1 )}} \frac{( n - 1 ) !}{{( n - 1 )}^{n - 1}} \\ n = {( \frac{{T}_{0}}{{T}_{0} - {T}_{q}} )}^{2} + 1\end{matrix} ;$$
calculating parameters T₁ and T₂ of the load feedforward controller G_{F}(s) as follows:
$$\{ \begin{matrix}{T}_{1} = {T}_{2} + {T}_{p} + τ - ( {T}_{0} + x ) \\ \begin{matrix}{T}_{2} = \frac{2 τ {T}_{p} + {( τ - {T}_{0} - x )}^{2} + ( x - 2 {T}_{p} ) ( {T}_{0} + x )}{2 ( {T}_{p} + τ - {T}_{0} - x )} \\ x = \frac{{( {T}_{0} - {T}_{q} )}^{2}}{{T}_{0}}\end{matrix}\end{matrix} ,$$
wherein x represents an intermediate variable.
